(19) United States
(12) Patent Application Publication
(10) Pub. No.: US 2008/0208673 A1
(43) Pub. Date: Aug. 28, 2008

(54) System and Method for Providing a Sample of a Product to Shoppers

(75) Inventor: Robert Mebruer, Singapore (SG)

Correspondence Address: SUGHRUE MION, PLLC, 2100 PENNSYLVANIA AVENUE, N.W., SUITE 800, WASHINGTON, DC, 20037, US

(73) Assignee: U-Marketing Intellectual Properties PTE. LTD., Singapore (SG)

(21) Appl. No.: 11/631,784

(22) PCT Filed: Jul. 8, 2005
(86) PCT No.: PCT/SG05/00224

§ 371 Date: Oct. 9, 2007

(30) Foreign Application Priority Data
Jul. 8, 2004 (AU) 2004903763

(51) Int. Cl. G06Q 30/00; G06F 17/30; G06F 17/40; G06F 19/00

(52) U.S. Cl. 705/10; 705/14; 235/381

(57) ABSTRACT

A system and method for providing a sample of a product to shoppers is disclosed. A card reader (115) is provided for reading a shopper's card to identify the shopper and a targeted list (111) of promotions for that shopper can be generated by a printer (116). Sample products which are to be received by the customer, together with the promotional product list, is produced by a processor (P1). The processor (P1) also determines the retail outlets to which sample products should be provided based on the shoppers who are to receive the samples and the home retail outlet at which the shopper shops.

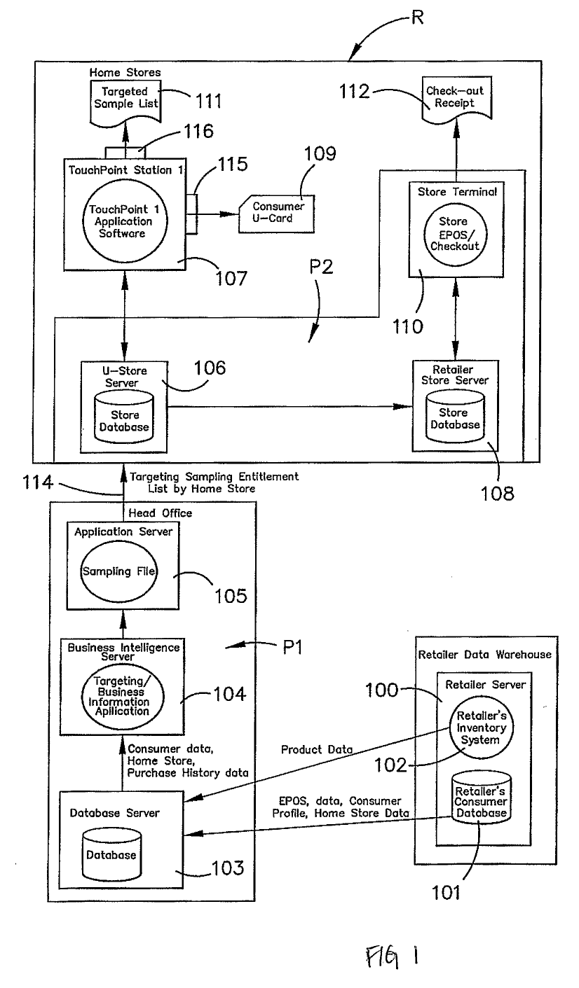

### FIELD OF THE INVENTION

This invention relates to a system and method for providing samples of products to shoppers and, in particular, free samples which are intended to alert the shopper to the existence of the product and entice the shopper to purchase that product in preference to a competing product, or alert the shopper to a newly launched product.

### BACKGROUND OF THE INVENTION

The provision of free samples of products to consumers is one way of advertising products and enticing a consumer to select that particular product in preference to competing products.

Traditionally, the providing of samples has been rather inefficient and produces a high level of wastage. Methods of providing free samples include inserting a free sample of a product into a newspaper or other publication, delivering free samples to consumers at random, either by drop off into a consumer's letterbox or by promotional people providing free samples to people in heavy traffic environments, such as shopping malls and the like. Other systems include providing products at checkouts in supermarkets and other stores based on a consideration of the type of products just purchased by the consumer.

These methods of providing free samples are rather ad hoc in nature and may not be directed to the particular people who have interest in purchasing the product, thereby creating significant wastage because of the supply of product to people who simply have no interest in the product.

Furthermore, another difficulty which arises with advertising products by way of samples is the need to provide the samples at a particular location. This is a logistic problem because the categorising and delivering of samples to particular areas may result in an over-supply in one area and an under-supply in another area.

### SUMMARY OF THE INVENTION

An object of a first aspect of the invention is to provide a better system and method for providing samples to shoppers.

The invention, in a first aspect, may be said to reside in a system for providing a sample of a product to shoppers, comprising:
an input device for receiving an input to identify a shopper;
a database for storing characteristics of shoppers to provide information upon which a decision can be made as to whether a shopper is to receive a sample of a product;
a processor for determining shoppers who are to receive the sample; and
an output device for providing an indication that a shopper is to receive a sample.

Thus, with the system according to the invention, a decision as to whether a shopper can receive a product is based on characteristics relating to the shopper, and therefore the determination of whether a sample is applicable is likely to be more relevant to the shopper. Thus, less wastage of providing samples is likely to occur.

In one embodiment of the invention, the input device comprises a card reader for reading a card belonging to the shopper to identify the shopper. The card may include data identifying the shopper by way of a pin number or other identifying data.

The card may be a smart card or a simple card having a magnetic strip.

In one embodiment of the invention, the database is retained in a central location and the processor comprises a first processor at the central location, the first processor receiving data from the database and processing the data for creating a sample file of samples to be provided for particular shoppers based on the stored characteristics in the database, and products which are desired to be advertised by way of the provision of samples.

Preferably the processor includes a second processor located at a retail outlet for receiving the sample file, the second processor being coupled to the output device for causing the output device to provide an indication of a shopper to receive a sample in response to the input into the input device.

In one embodiment, the output device may comprise a printer which prints a sample list in response to a shopper inputting information into the input device to identify the shopper so the shopper can present the list to collect the free samples applicable to that shopper.

In another embodiment, the output device may comprise an EPOS checkout location in a store for providing the indication of the shopper to receive the sample.

In other embodiments, the output device may comprise other devices for alerting a shopper to the fact that a free sample is available such as by way of text message or telephone call to a mobile telephone.

Preferably the database also stores information relating to shoppers which identifies a home retail outlet at which the shopper purchase products and preferably, the first processor forwards the sample list to the second processor located at that retail outlet. By identifying retail outlets at which shoppers are likely to shop, the distribution of free samples to retail outlets operating the system is made more easy and free samples are provided to the store where they are most likely to be received by shoppers. Thus, the over-supply or under-supply of samples at particular locations is reduced and samples are provided at locations where they are likely to be most required.

Most preferably the first processor includes the said database, a server for determining products which are to be advertised by way of a free sample, and the targeted shoppers for receiving those free samples, and an application server for generating the sample file for transmission to the second processor.

Preferably a said second processor is located at each retail stores operating the system, the second processor including a database for receiving the sample files transmitted from the first processor, and for controlling the output device to provide the indication of free samples applicable to the shopper.

The invention, in a first aspect, may be said to reside in a method of providing a sample of a product to shoppers, comprising:
identifying a shopper;
determining if the shopper is to receive a sample from a database storing characteristics of shoppers; and
outputting an indication that the shopper is to receive a sample.

In one embodiment of the invention, the identification of a shopper is by a card reader for reading a card belonging to the shopper to identify the shopper. The card may include data identifying the shopper by way of a pin number or other identifying data.

In one embodiment of the invention, the database is retained in a central location and the method further comprises processing data from the database to create a sample file of samples to be provided for particular shoppers based on the stored characteristics in the database, and products which are desired to be advertised by way of the provision of samples.

Preferably the method also comprises receiving the sample file at a retail outlet and processing the sample file and information identifying shoppers at the retail outlet to provide an indication of the shoppers to receive a sample.

In one embodiment, providing the indication comprises printing a sample list in response to a shopper inputting information into the input device to identify the shopper so the shopper can present the list to collect the free samples applicable to that shopper.

In another embodiment, the indication is provided at an EPOS checkout location in a store for providing the indication of the shopper to receive the sample.

In other embodiments, the indication may comprise other ways of alerting a shopper to the fact that a free sample is available such as by way of text message or telephone call to a mobile telephone.

Preferably the method also comprises identifying a home outlet at which the shopper purchase products and forwarding the sample list to that retail outlet. By identifying retail outlets at which shoppers are likely to shop, the distribution of free samples to retail outlets operating the system is made more easy and free samples are provided to the store where they are most likely to be received by shoppers. Thus, the over-supply or under-supply of samples at particular locations is reduced and samples are provided at locations where they are likely to be most required.

Most preferably the processing at the central location is performed by a first processor which includes the said database, a server for determining products which are to be advertised by way of a free sample, and the targeted shoppers for receiving those free samples, and an application server for generating the sample file for transmission to the second processor.

Preferably the processing at the retail outlet is performed by a second processor located at a retail store operating the system, the second processor including a database for receiving the sample files transmitted from the first processor, and for controlling the output device to provide the indication of free samples applicable to the shopper.

A further aspect of the invention is concerned with supplying free samples to locations where the free samples are likely to be used so as to minimise over-supply or under-supply of samples.

This aspect of the invention may be said to reside in a system for providing a sample of a product to shoppers, comprising:
a database for storing characteristics of shoppers to provide information upon which a decision can be made as to whether a shopper is to receive a sample of a product, and also information identifying a home retail outlet at which shoppers shop; and
a processor for determining products which are to be advertised by way of provision of a sample, and shoppers who are to receive those samples, and for determining retail outlets to which sample products should be provided for supply to shoppers based on the shoppers who are to receive the free samples, and the home retail outlet at which the shopper shops.

Thus, according to this aspect of the invention, once the particular samples which are to be provided are determined and the shoppers and their primary retail outlets determined, samples can be provided in accordance with the particular numbers of shoppers at particular retail outlets so as to reduce the under-supply or over-supply of samples to particular locations, and to make it more likely that the desired number of samples will be available for collection by the identified people at particular retail outlets.

Preferably the system further comprises an input device for receiving an input to identify a shopper and an output device for providing an indication that a shopper is to receive the sample.

In one embodiment of the invention, the input device comprises a card reader for reading a card belonging to the shopper to identify the shopper. The card may include data identifying the shopper by way of a pin number or other identifying data.

In one embodiment of the invention, the database is retained in a central location and the processor comprises a first processor at the central location, the first processor receiving data from the database and processing the data for creating a sample file of samples to be provided for particular shoppers based on the stored characteristics in the database, and products which are desired to be advertised by way of the provision of samples.

Preferably the processor includes a second processor located at a retail outlet for receiving the sample file, the second processor being coupled to the output device for causing the output device to provide an indication of the shoppers to receive a sample.

In one embodiment, the output device may comprise a printer which prints a sample list in response to a shopper inputting information into the input device to identify the shopper so the shopper can present the list to collect the free samples applicable to that shopper.

In another embodiment, the output device may comprise an EPOS checkout location in a store for providing the indication of the shopper to receive the sample.

In other embodiments, the output device may comprise other devices for alerting a shopper to the fact that a free sample is available such as by way of text message or telephone call to a mobile telephone.

Most preferably the first processor includes the said database, a server for determining products which are to be advertised by way of a free sample, and the targeted shoppers for receiving those free samples, and an application server for generating the sample file for transmission to the second processor.

Preferably a said second processor is located at separate retail stores operating the system, the second processor including a database for receiving the sample files transmitted from the first processor, and for controlling the output device to provide the indication of free samples applicable to the shopper.

This aspect of the invention may be said to reside in a method of providing a sample of a product to shoppers, comprising:
maintaining a database for storing characteristics of shoppers to provide information upon which a decision can be made as to whether a shopper is to receive a sample of a product, and also information relating to identify a home retail outlet at which shoppers shop; and
determining products which are to be advertised by way of provision of a sample, and shoppers who are to receive those samples, and retail outlets to which sample products should be provided for supply to shoppers based on the shoppers who are to receive the free samples, and the home retail outlet at which the shopper shops.

Preferably the method further comprises distributing samples to various retail outlets in accordance with the identification of shoppers to receive those samples and the home retail outlet associated with those shoppers.

In one embodiment of the invention, the identification of a shopper is by a card reader for reading a card belonging to the shopper to identify the shopper. The card may include data identifying the shopper by way of a pin number or other identifying data.

In one embodiment of the invention, the database is retained in a central location and the method further comprises processing data from the database to create a sample file of samples to be provided for particular shoppers based on the stored characteristics in the database, and products which are desired to be advertised by way of the provision of samples.

Preferably the method also comprises receiving the sample file at a retail outlet and processing the sample file and information identifying shoppers at the retail outlet to provide an indication of the shoppers to receive a sample.

In one embodiment, providing the indication comprises printing a sample list in response to a shopper inputting information into the input device to identify the shopper so the shopper can present the list to collect the free samples applicable to that shopper.

In another embodiment, the indication is provided at an EPOS checkout location in a store for providing the indication of the shopper to receive the sample.

In other embodiments, the indication may comprise other ways of alerting a shopper to the fact that a free sample is available such as by way of text message or telephone call to a mobile telephone.

Most preferably the processing at the central location is performed by a first processor which includes the said database, a server for determining products which are to be advertised by way of a free sample, and the targeted shoppers for receiving those free samples, and an application server for generating the sample file for transmission to the second processor.

Preferably the processing at the retail outlet is performed by a second processor located at a retail store operating the system, the second processor including a database for receiving the sample files transmitted from the first processor, and for controlling the output device to provide the indication of free samples applicable to the shopper.

### BRIEF DESCRIPTION OF THE DRAWING

A preferred embodiment of the invention will be described, by way of example, with reference to the accompanying drawing which shows a schematic block diagram of a system according to the preferred embodiment of the invention.

### DETAILED DESCRIPTION OF THE PREFERRED EMBODIMENT

With reference to the accompanying drawing, a first processor P1 is located at a central location and second processors P2 are located at retail outlets R (only one retail outlet R and one processor P2 being shown in the drawing). The processor P1 is coupled to the processor P2 for the transmission of data by hardwiring, a network connection, internet connection or the like.

The processor P1 includes a database 103 which contains a database of shoppers and particular characteristics of shoppers. The characteristics include demographic information, products of preference based on shopping history of shoppers, and also personal information such as whether the shopper has children, pets, and attitudinal behaviour, and other information upon which a decision can be based as to whether a shopper is likely to be interested in a particular type of product. This information can be obtained from the shopping habits of particular shoppers, and also by a shopper filling in an application form to join the system and providing that information.

The database therefore contains data relating to the past purchase behaviour of a consumer and, additionally, attitudinal segmentation, geo-demographics and any other criteria categorizing shoppers. The benefit of including attitudinal segmentation means that data relating to the general attitudes of consumers is provided. This allows the selection of future customers and the targeting of those customers based on their perceptions (for example, how they perceive different attitudes and benefits of marketing brands, and how these represent marketing opportunities). Thus, products which may not have been purchased by the consumer or completely new products may be targeted to consumers based on an analysis of what those consumers perceive and what they are likely to purchase based on their attitudinal behaviour. Similarly, consumers can be segmented based on different attitudes, interests, opinions and lifestyles, which provides much better targeting than simple reliance on past purchase history. Geo-demographics enables targeting based on family size, educational levels, where people live and work, and also provides better targeting of people over simple past purchase history. Thus, the present embodiments allow better flexibility by using purchase behaviour, attitude, lifestyle, psychographics, geo-demographics or a combination of these various parameters, and better targeting because as more selection criteria is developed, the targeting is tighter and sharper. Furthermore, the actual size of the target selection is known and qualification is predetermined, allowing clear ideas of cost of promotional programs, opportunities and competitive dynamics. Hence, the targeting can be scaled up or down according to the flexibility of extending or limiting the targeting criteria. In the preferred embodiments of the invention, the focus on determining, analytical and business intelligent tools and key strategy development is very much more extensive and the nature of the data retained so that target groups can be predetermined and forwarded to stores where those shoppers shop to identify, match and offer the specific shopping lists or shopping coupons to the targeted group of consumers.

As is shown in the drawing, the database 103 is connected to a retailer's server 100. The retail server 100 may relate to a number of retail outlets R (only one shown in the drawings for ease of illustration) which are operated by the same organisation. Thus, a chain of retail outlets R may include, for example, ten different retail stores. A single server 100 is associated with all of those stores belonging to the same chain and may, for example, be located at an administrative office of the chain of stores. A different chain of stores will have its own server 100 for that particular chain of stores. The retail server 100 includes the retailer's inventory system which contains information as to all of the products available in the retail outlet, and also a consumer database 101 which compiles information relating to consumers who shop in the store, the nature of products purchased, and also identifying data identifying the store. The database 101 collects information from the store EPOS checkout system 110 relating to products purchased by particular customers. Thus, a database of a particular customer identification and products purchased by that customer is obtained in each of the retail outlets R. The products purchased by a shopper are identified by the barcodes of the products as they are scanned at checkout and therefore a database is built up of products of particular interest to particular shoppers. The data which is collected at each of the stores in a particular chain of stores is provided to the server 100 associated with that chain of stores. The information can be provided from the stores by way of a communication link to the server 100 or by otherwise loading information collected at the various store locations into the server 100. That data in the servers 100 is forwarded to the database 103 at the central location for compiling all of the data relating to shoppers and characteristics from all of the stores operating the system.

The data contained in the retail server 100 is supplied to the database 103 via a communication link which again may be one of the types of links referred to above.

Thus, the database 103 is loaded with information which identifies particular shoppers, products of interest to those shoppers, and demographic and other personal information relating to the shoppers.

The processor P1 also includes a server 104 which includes software to process information relating to sample products which are intended to be provided, and also data contained in the database 103 to identify shoppers who are likely to be interested in a particular sample. The server 104 creates a targeting list and sorts the list and categorises the list in accordance with the participating marketer's parameters for sampling. That is, the type of people the provider of the product wishes to attract and are therefore likely to be interested in receiving a sample. The list from the server 104 is provided to the application server 105, and the application server generates a sample file to re-categorise only the qualifying groups of consumers, and creates a targeted sampling entitlement list for each of the home retail stores at which the targeted shoppers shop. Those lists are then sent to the various retail stores R by communication link 114. Thus, for each of the home stores, a list is forwarded which is then received in the store database 106 of the relevant retail outlet R.

Thus, the system collects purchase data from past purchases by shoppers, and identifies the shoppers who make the purchases, matching them with the particular home store at which they shop. By further matching the marketer's parameters (i.e. the supplier of the product which is to be advertised by way of samples) of what and whom the marketer's intended market is, a sample file on the server 105 is created which typically includes information on the specific number of consumers at each participating home store. The relevance of receiving the free samples and based on the marketer's parameters, such as demographics, attitude, purchase behaviour, etc. The sample file generated by the server 105 further identifies each of the targeted consumers and generates the targeted sampling entitlement list which is then sent electronically to each of the servers 106 at each relevant home store R.

The list which is received by the databases 106 in each of the retail outlets R is loaded into the computer 107 which is also connected to an input device such as a card reader for receiving a shopper's card 109 which identifies the shopper. The computer 107 also has a printer 116 which prints a targeted sample list 111 for that particular shopper. Thus, when a shopper presents at the store, the shopper simply inserts his or her card 109 into the reader 115 and if any samples are applicable to that particular shopper, the list 111 is printed by the printer 116. The shopper is therefore provided with a list of sample products which the shopper may collect.

In the case of the retail outlet being a virtual retail outlet which is accessed by the internet, the input of data identifying the user can be by way of pin number typed into a keyboard and the list 111 can be provided by way of a web page or mobile phone via text (SMS or MMS). Obviously the products are not available at the person's home where the virtual shopping is conducted, and the person would need to visit a particular retail outlet or other location in order to collect the free samples.

The list 111 may also comprise a shopping list which is generated to provide the shopper with specific information and product ranges which the shopper may like to purchase in the store to obtain particular benefits or rewards. Details of the manner in which the shopping list is generated is disclosed in our co-pending Australian Provisional Application No. 2004903120. The contents of that provisional application are incorporated into this specification by this reference.

Depending on the communication method within the retail outlet R, rather than, or as well as, supplying the list to the computer 107, the list may be supplied from the database 106 to the retail store server database 108. The retail store database 108 in turn loads the information into the store checkout terminal 110 so that when a purchaser presents his or her card at checkout to pay for products, the checkout receipt 112 includes a list of the samples which should be provided to the shopper.

Thus, according to the preferred embodiments of the invention, the shopper may obtain the list before shopping commences, or when checking out, and the samples can be collected either at checkout or from any relevant location within the store.

Because the server 104 and the server 105 generate lists of shoppers who are expected to receive sample products, and also the stores at which those shoppers shop, the processor P1 may also determine where sample products should be forwarded so as to ensure that the right quantity of sample products are available for collection. Thus, this ensures that sample products are forwarded to the locations where they are needed, and reduces the likelihood of an over-supply or under-supply of sample products at a particular retail outlet R. Thus, the products are more efficiently provided where they are needed, and also the people to receive the samples are more likely to be interested in the sample product, and therefore more likely to eventually purchase the product.

In the claims which follow and in the preceding description of the invention, except where the context requires otherwise due to express language or necessary implication, the word “comprise”, or variations such as “comprises” or “comprising”, is used in an inclusive sense, i.e. to specify the presence of the stated features but not to preclude the presence or addition of further features in various embodiments of the invention.

Since modifications within the spirit and scope of the invention may readily be effected by persons skilled within the art, it is to be understood that this invention is not limited to the particular embodiment described by way of example hereinabove.

1. A system for providing a sample of a product to shoppers, comprising:
an input device for receiving an input to identify a shopper;
a database for storing characteristics of shoppers to provide information upon which a decision can be made as to whether a shopper is to receive a sample of a product;
a processor for determining shoppers who are to receive the sample; and
an output device for providing an indication that a shopper is to receive a sample.

2. The system of claim 1 wherein the input device comprises a card reader for reading a card belonging to the shopper to identify the shopper.

3. The system of claim 1 wherein the database is retained in a central location and the processor comprises a first processor at the central location, the first processor receiving data from the database and processing the data for creating a sample file of samples to be provided for particular shoppers based on the stored characteristics in the database, and products which are desired to be advertised by way of the provision of samples.

4. The system of claim 3 wherein the processor includes a second processor located at a retail outlet for receiving the sample file, the second processor being coupled to the output device for causing the output device to provide an indication of a shopper to receive a sample in response to the input into the input device.

5. The system of claim 1 wherein the output device comprises a printer which prints a sample list in response to a shopper inputting information into the input device to identify the shopper so the shopper can present the list to collect the free samples applicable to that shopper.

6. The system of claim 1 wherein the output device comprises an EPOS checkout location in a store for providing the indication of the shopper to receive the sample.

7. The system of claim 1 wherein the database also stores information relating to shoppers which identifies a home retail outlet at which the shopper purchase products and preferably, the first processor forwards the sample list to the second processor located at that retail outlet.

8. The system of claim 3 wherein the first processor includes the said database, a server for determining products which are to be advertised by way of a free sample, and the targeted shoppers for receiving those free samples, and an application server for generating the sample file for transmission to the second processor.

9. The system of claim 3 wherein a said second processor is located at each retail stores operating the system, the second processor including a database for receiving the sample files transmitted from the first processor, and for controlling the output device to provide the indication of free samples applicable to the shopper.

10. A method of providing a sample of a product to shoppers, comprising:
identifying a shopper;
determining if the shopper is to receive a sample from a database storing characteristics of shoppers; and
outputting an indication that the shopper is to receive a sample.

11. The method of claim 10 wherein the identification of a shopper is by a card reader for reading a card belonging to the shopper to identify the shopper.

12. The method of claim 10 wherein the database is retained in a central location and the method further comprises processing data from the database to create a sample file of samples to be provided for particular shoppers based on the stored characteristics in the database, and products which are desired to be advertised by way of the provision of samples.

13. The method of claim 10 wherein the method also comprises receiving the sample file at a retail outlet and processing the sample file and information identifying shoppers at the retail outlet to provide an indication of the shoppers to receive a sample.

14. The method of claim 13 wherein providing the indication comprises printing a sample list in response to a shopper inputting information into the input device to identify the shopper so the shopper can present the list to collect the free samples applicable to that shopper.

15. The method of claim 13 wherein the indication is provided at an EPOS checkout location in a store for providing the indication of the shopper to receive the sample.

16. The method of claim 10 wherein the method also comprises identifying a home outlet at which the shopper purchase products and forwarding the sample list to that retail outlet.

17. The method of claim 12 wherein the processing at the central location is performed by a first processor which includes the said database, a server for determining products which are to be advertised by way of a free sample, and the targeted shoppers for receiving those free samples, and an application server for generating the sample file for transmission to the second processor.

18. The method of claim 13 wherein the processing at the retail outlet is performed by a second processor located at a retail store operating the system, the second processor including a database for receiving the sample files transmitted from the first processor, and for controlling the output device to provide the indication of free samples applicable to the shopper.

19. A system for providing a sample of a product to shoppers, comprising:
a database for storing characteristics of shoppers to provide information upon which a decision can be made as to whether a shopper is to receive a sample of a product, and also information identifying a home retail outlet at which shoppers shop; and
a processor for determining products which are to be advertised by way of provision of a sample, and shoppers who are to receive those samples, and for determining retail outlets to which sample products should be provided for supply to shoppers based on the shoppers who are to receive the free samples, and the home retail outlet at which the shopper shops.

20. The system of claim 19 wherein the system further comprises an input device for receiving an input to identify a shopper and an output device for providing an indication that a shopper is to receive the sample.

21. The system of claim 20 wherein the input device comprises a card reader for reading a card belonging to the shopper to identify the shopper.

22. The system of claim 19 wherein the database is retained in a central location and the processor comprises a first processor at the central location, the first processor receiving data from the database and processing the data for creating a sample file of samples to be provided for particular shoppers based on the stored characteristics in the database, and products which are desired to be advertised by way of the provision of samples.

23. The system of claim 22 wherein the processor includes a second processor located at a retail outlet for receiving the sample file, the second processor being coupled to the output device for causing the output device to provide an indication of the shoppers to receive a sample.

24. The system of claim 23 wherein the output device comprises a printer which prints a sample list in response to a shopper inputting information into the input device to identify the shopper so the shopper can present the list to collect the free samples applicable to that shopper.

25. The system of claim 23 wherein the output device comprises an EPOS checkout location in a store for providing the indication of the shopper to receive the sample.

26. The system of claim 22 wherein the first processor includes the said database, a server for determining products which are to be advertised by way of a free sample, and the targeted shoppers for receiving those free samples, and an application server for generating the sample file for transmission to the second processor.

27. The system of claim 23 wherein a said second processor is located at separate retail stores operating the system, the second processor including a database for receiving the sample files transmitted from the first processor, and for controlling the output device to provide the indication of free samples applicable to the shopper.

28. A method of providing a sample of a product to shoppers, comprising:
maintaining a database for storing characteristics of shoppers to provide information upon which a decision can be made as to whether a shopper is to receive a sample of a product, and also information relating to identify a home retail outlet at which shoppers shop; and
determining products which are to be advertised by way of provision of a sample, and shoppers who are to receive those samples, and retail outlets to which sample products should be provided for supply to shoppers based on the shoppers who are to receive the free samples, and the home retail outlet at which the shopper shops.

29. The method of claim 28 wherein the method further comprises distributing samples to various retail outlets in accordance with the identification of shoppers to receive those samples and the home retail outlet associated with those shoppers.

30. The method of claim 28 wherein the identification of a shopper is by a card reader for reading a card belonging to the shopper to identify the shopper.

31. The method of claim 28 wherein the database is retained in a central location and the method further comprises processing data from the database to create a sample file of samples to be provided for particular shoppers based on the stored characteristics in the database, and products which are desired to be advertised by way of the provision of samples.

32. The method of claim 28 wherein the method also comprises receiving the sample file at a retail outlet and processing the sample file and information identifying shoppers at the retail outlet to provide an indication of the shoppers to receive a sample.

33. The method of claim 32 wherein providing the indication comprises printing a sample list in response to a shopper inputting information into the input device to identify the shopper so the shopper can present the list to collect the free samples applicable to that shopper.

34. The method of claim 32 wherein the indication is provided at an EPOS checkout location in a store for providing the indication of the shopper to receive the sample.

35. The method of claim 31 wherein the processing at the central location is performed by a first processor which includes the said database, a server for determining products which are to be advertised by way of a free sample, and the targeted shoppers for receiving those free samples, and an application server for generating the sample file for transmission to the second processor.

36. The method of claim 32 wherein the processing at the retail outlet is performed by a second processor located at a retail store operating the system, the second processor including a database for receiving the sample files transmitted from the first processor, and for controlling the output device to provide the indication of free samples applicable to the shopper.
